(19) United States
(12) Patent Application Publication
(10) Pub. No.: US 2004/0018374 A1
(43) Pub. Date: Jan. 29, 2004

(54) Use of PUR powder coating materials for coil coatings featuring a matt appearance

(75) Inventors: Andreas Wenning, Nottuln (DE); Joern Volker Weiss, Haltern am See (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/622,639

(22) Filed: Jul. 21, 2003

(30) Foreign Application Priority Data
Jul. 20, 2002 (DE) 102 33 104.9

(51) Int. Cl. B05D 1/12

(52) U.S. Cl. 428/603; 427/180; 428/615

(57) ABSTRACT

Polyurethane powder coating materials including polyureas, polyesters, and crosslinkers are deposited on metal coils to form coatings having a matt finish.

### BACKGROUND OF THE INVENTION

1. Field of the Invention

The invention describes the use of polyurethane (PUR) powder coating materials comprising polyureas, polyesters, and crosslinkers for matt powder coil coatings, a process for producing such coatings, and the coils coated with such coating materials.

2. Description of the Background

Since 1970, thermosetting pulverulent materials have been known which are obtained by reacting a hydroxyl-containing resin with a blocked polyisocyanate. Of the blocked polyisocyanates, isophorone diisocyanate adducts blocked with ε-caprolactam have become established as curatives for PUR powders. The PUR powders prepared using these curatives are employed for coating a wide variety of metal articles, on account of their superior weathering stability and thermal color stability. Powders of this kind are described in, for example, DE 27 35 497. Using these powders, ready-formed metal components are coated piece by piece (post-coated metal).

Coil coating, in contrast, is a process for coating metal coils at speeds from 60 to 200 m/min. Metal sheets, preferably of steel or aluminum, are cleaned and coated with a paint. These sheets are then passed on for further processing, where they acquire their actual form. The principal applications are trapezoidal profiles coated with weather-resistant paints, for roofs and facings, for example, and also doors, window frames, gates, guttering, and blinds. For the interior, coil-coated metal sheets are employed primarily for partition walls and ceiling elements. Other fields of use, however, include steel furniture, shelving, shop fitting, and appliance casings. Lamps and light fittings form a further important application segment. There is also a broad applications pallet in the vehicle sector. Truck bodies and exterior-mounted automotive components are often manufactured from precoated materials.

To coat the substrate employed, a pretreatment is generally carried out. As a first coating film, a primer is applied in a thickness of from 5 to 10 μm to what will subsequently be the visible side. Following the first pass through the dryer, the actual topcoat is applied. After drying, it has a film thickness of approximately 20 μm. In some cases this surface is laminated further, in the hot state, with a temporary protective sheet. This is intended to protect it against mechanical injury. In parallel with the coating of the visible sides, the reverse sides as well are coated. Primers used include, for example, polyester resins. For coil-coated facings and roofs under corrosive industrial atmospheric conditions, epoxy-containing systems are used as primers. As topcoat materials, liquid coating materials in innumerable colors are primarily employed. Depending on the field of application, polyester, polyurethane or PVDF topcoat materials, for example, are used. The film thicknesses of the topcoats are normally about 20 μm.

Besides the liquid primers and topcoats, powder coating materials are also used for the coating of metal coils. Powder coating materials have the great advantage over their liquid counterparts of being solvent-free and hence more ecological. However, their proportion among the coil coating systems has to date been relatively low.

One of the reasons was the high powder coating film thicknesses of more than 40 μm. These lead to optical defects, since the surface is no longer entirely free from pores. This drawback was eliminated by WO 97/47400. It describes a process for coating metal coils, with which powder film thicknesses of less than 20 μm can be obtained.

A second disadvantage as compared with liquid coating materials was the extremely slow coil speed during application of the powder coating material. Using electrostatic spray guns, metal coils can be coated with powder coating material only at line speeds of a maximum of 20 m/min. As a result of the MSC Powder CloudTM technology, described by, for example, F. D. Graziano, XXIIrd International Conference in Organic Coatings, Athens, 1997, pages 139-150 or by M. Kretschmer, 6th DFO Conference on Powder Coating Practice, Dresden, 2000, pages 95-100, coil speeds of from 60 to 100 m/min are now realizable.

PUR powder coating materials are renowned, inter alia, for their high weathering stability, excellent leveling, and good flexibility. For use in coil coating, however, the flexibility of the systems known to date is often inadequate. Consequently, new PUR powder coating materials have been developed which satisfy the extreme flexibility requirement imposed on coil coatings. For example, DE 101 59 768 and DE 101 59 488 describe highly flexible PUR powder coatings suitable for the coating of metallic substrates by the coil coating process. As a result, the third critical disadvantage in comparison to conventional liquid coatings has also been removed.

Within the field of coil coating materials, there exists great interest in coatings featuring a matt surface. The reason for this is first and foremost practical. Glossy surfaces require a far higher degree of cleaning than do matt surfaces. In addition, it can be desirable for safety reasons to avoid strongly reflecting surfaces.

The simplest method of obtaining a matt surface is to admix smaller or larger amounts of fillers, such as chalk, finely divided silica or barium sulfate, for example, to the powder coating material in accordance with the extent of the desired matt effect. However, such additions result in a deterioration in the film properties of the coating, such as adhesion, flexibility, impact strength, and chemical resistance.

The addition of substances incompatible with the coating material, such as waxes or cellulose derivatives, for example, clearly gives rise, it is true, to matting, but slight changes in the course of extrusion lead to fluctuations in the surface gloss. The reproducibility of the matt effect is not guaranteed.

The object was to find novel PUR powder coating materials for the coating of metal coils featuring a matt appearance by the coil coating process which are easy to prepare and whose matt effect should be freely adjustable, while maintaining the good mechanical properties of the powder coatings.

### SUMMARY OF THE INVENTION

The present invention provides novel PUR powder coating materials for the coating of metal coils featuring a matt appearance by the coil coating process which are easy to prepare and whose matt effect is freely adjustable, while maintaining the good mechanical properties of the powder coating. It has surprisingly been found that through the combination of polyurea and polyester it is possible to obtain PUR powder coating materials whose coatings on metallic substrates produced by the coil coating process combine low gloss levels with outstanding mechanical and optical properties.

In particular, the present invention provides for the use of polyurethane powder coating materials for coating metal coils by the coil coating process, the polyurethane powder coating materials comprising

A) 3-25% by weight of polyurea;

B) 35-75% by weight of at least one amorphous and/or (semi)crystalline polyester having a hydroxyl number of from 5 to 250 mg KOH/g and a melting point of from 50 to 130° C.;

C) 5-30% by weight of at least one crosslinker based on blocked polyisocyanates and/or isocyanurates and/or uretdiones having a functionality of at least 2;

D) 0.5-50% by weight of auxiliaries and additives; and there being from 0.5 to 1.2 NCO groups of component C) available per OH group of component B).

The PUR powder coating materials are described in EP 1 184 433 and in EM 020122 (internal file reference).

The polyureas used are composed of at least one amine having a functionality of at least two and one isocyanate. The NCO/NH₂ ratio of the two components is normally from 0.9 to 1.1:1.

Polyureas are known and are described in, for example:

Houben-Weyl E 20/2 (1987) pages 1721-1751;

Houben-Weyl XIV/2 (1963) pages 165-171.

In the context of the invention it is possible to use all brittle, high-melting polyureas, examples being those formed from aliphatic, (cyclo)aliphatic, cycloaliphatic, and aromatic diamines and/or polyamines (C5-C18) and the corresponding isocyanates or else other isocyanates (in the form of diisocyanates and in the form of their oligomers, e.g., isocyanurates).

Particularly suitable are the diisocyanates and/or isocyanurates of isophorone diisocyanate (IPDI), hexamethylene diisocyanate (HDI) and 4,4′-dicyclohexylmethane diisocyanate (HMDI).

One preferred embodiment of the invention is the use of polyureas based on nonaromatic amines and isocyanates, such as isophoronediamine (IPD) and isophorone diisocyanate (IPDI) and/or HDI, it being possible to use the diisocyanate alone, as the isocyanurate and in mixtures of this kind. The polyureas used with preference are described in DE 100 42 322 and are part of the disclosure content of this specification.

Component B) comprises amorphous and/or (semi)crystalline polyesters.

The amorphous polyesters B) have a functionality of from 2.0 to 5.0, preferably from 2.0 to 4.2, an OH number of from 5 to 250 mg KOH/g, in particular from 20 to 250 mg KOH/g, a viscosity at 160° C. of <60,000 m·Pas, a melting point of from 50° C. to 130° C., preferably from 70 to 120° C., and a glass transition temperature of >40° C.

The (semi)crystalline polyesters B) have a functionality of from 2.0 to 4.0, an OH number of from 5 to 250 mg KOH/g, in particular from 5 to 150 mg KOH/g, a melting point of from 50° C. to 130° C., and a glass transition temperature of <−10° C.

Suitable for preparing the polyester B) in the context of the invention are in principle all known linear and/or branched polyols and polycarboxylic acids and/or their esters and/or anhydrides. Suitable polyols are described in, for example, DE 27 35 497 and 30 04 903. Suitable polycarboxylic acids are described in, for example, DE 101 59 488.

Polyols used with preference are monoethylene glycol, diethylene glycol, neopentylglycol hydroxypivalate, butane-1,4-diol, pentane-1,2-diol, pentane-1,5-diol, hexane-1,6-diol, dodecane-1,12-diol, cyclohexanediol, neopentylglycol, 1,4-bis(hydroxymethyl)cyclohexane, trimethylolpropane, glycerol or pentaerythritol.

Carboxylic acids used with preference and/or their esters and/or anhydrides are terephthalic acid, isophthalic acid, phthalic acid, adipic acid, azelaic acid, succinic acid, sebacic acid, dodecanedioic acid, hexahydroterephthalic acid, hexahydrophthalic acid, 1,4-cyclohexanedicarboxylic acid, trimellitic acid or pyromellitic acid.

The polyesters may be obtained in conventional manner by condensing polyols and polycarboxylic acids in an inert gas atmosphere at temperatures from 100 to 260° C., preferably from 130 to 220° C., in the melt or azeotropically, as described, for example, in Methoden der Organischen Chemie (Houben-Weyl), Vol. 14/2, 1-5, 21-23, 40-44, Georg Thieme Verlag, Stuttgart, 1963, in C. R. Martens, Alkyd Resins, 51-59, Reinhold Plastics Appl. Series, Reinhold Publishing Comp., New York, 1961 or in DE 27 35 497 and DE 30 04 903.

As crosslinkers C) based on polyisocyanates it is possible in principle to use the known curatives in the field of powder coating materials. Preference is given to using polyisocyanates containing blocking agents and also internally blocked polyisocyanates. They are described in, for example, DE 21 05 777, 25 42 191, 27 35 497, 30 39 824, 30 30 572,30 30 513, 37 39 549, 101 59 768 and 101 59 488.

For instance, the powder coating materials of the invention may comprise crosslinkers C) based on blocked polyisocyanates, blocked isocyanurates, and uretdiones, alone or in mixtures. The starting components are preferably selected from IPDI, HDI, and HMDI.

Blocking agents which can be used are the known ones. Preference is given to using caprolactam, triazoles, oximes or pyrazoles, alone or in mixtures.

The ratio of resin (component B) to crosslinker (component C) is chosen such that there are from 0.5 to 1.2, preferably 0.8-1.0, NCO groups available per OH group of the resin.

The auxiliaries and additives D) present in the PUR powder coating materials of the invention are, for example, leveling agents, pigments, fillers, dyes, catalysts, light stabilizers, heat stabilizers, antioxidants and/or effect additives. They are normally present in amounts of 0.5-50% by weight.

To prepare the ready-to-use powder coating materials, components A), B), C) and D) are homogenized in the melt. This can be done in suitable apparatus, such as in heatable compounders, for example, but takes place preferably by extrusion, during which temperature limits of from 130 to 140° C. ought not to be exceeded. After cooling to room temperature and appropriate comminution, the extruded homogenized material is ground to give the ready-to-spray powder and is sieved off to a particle size <100 μm.

The invention also provides a process for coating metal coils by the coil coating process by using polyurethane powder coating materials comprising

A) 3-25% by weight of polyurea;

B) 35-75% by weight of at least one amorphous and/or (semi)crystalline polyester having a hydroxyl number of from 5 to 250 mg KOH/g and a melting point of from 50 to 130° C.;

C) 5-30% by weight of at least one crosslinker based on blocked polyisocyanates and/or isocyanurates and/or uretdiones having a functionality of at least 2;

D) 0.5-50% by weight of auxiliaries and additives; and there being from 0.5 to 1.2 NCO groups of component C) available per OH group of component B), and also provides the coated metal coils themselves. The metal coils coated in accordance with the invention by the coil coating process have gloss levels of from 1 to 70 (60° angle).

The ready-to-spray powder can be applied to appropriate substrates by the known methods, examples being electrostatic powder spraying and fluidized-bed sintering with or without electrostatic assistance. Following powder application, the coated workpieces are cured conventionally by heating in an oven at a temperature of from 160 to 250° C. for from 60 minutes to 30 seconds, preferably at from 170 to 240° C. for from 30 minutes to 1 minute. When a coil coating oven is used the curing conditions are commonly 90 to 10 s at temperatures from 200 to 350° C.

In order to raise the gelling rate of the heat-curable powder coating materials it is possible to add catalysts. Examples of catalysts used include organotin compounds such as dibutyltin dilaurate, tin(II) octoate, dibutyltin maleate or butyltin tris(2-ethylhexanoate). The amount of catalyst added is from 0.01 to 1.0% by weight, based on the total amount of powder coating material.

With the coating composition used in accordance with the invention it is possible to produce extremely flexible, overbakeable, and weathering-stable powder coil coatings. The gloss level of these coatings on the metal coils can be varied in accordance with the intended use. In accordance with the invention, the gloss level varies from 1 to 70 (60° angle).

The subject matter of the invention is illustrated below with reference to examples.

### EXAMPLES

A) Polyurea

### Example 1

The polyurea (PH) was composed of 36% by weight isophoronediamine (IPD), 31% by weight isophorone diisocyanate (IPDI), and 32% by weight IPDI isocyanurate. The product was white, brittle, and insoluble in customary solvents. Decomposition occurred above 250° C.

### Example 2

The polyurea (PH) was composed of 28% by weight isophoronediamine (IPD), and 72% by weight IPDI isocyanurate. The product was white, brittle, and insoluble in customary solvents. Decomposition occurred above 250° C.

B) Polyester

### Example 1

The composition of the polyester was as follows: as acid component: 100 mol % succinic anhydride; as alcohol component: 100 mol % butane-1,4-diol. The polyester had an OH number of 31 mg KOH/g, an acid number of 2 mg KOH/g, and a melting point of 120° C.

### Example 2

The composition of the polyester was as follows: as acid component: 93 mol % terephthalic acid, 2.5 mol % isophthalic acid, 4.5 mol % adipic acid; as alcohol components: 88 mol % neopentyl glycol, 4 mol % pentane-1,2-diol, 8 mol % trimethylolpropane. The polyester had an OH number of 47 mg KOH/g, an acid number of 7.0 mg KOH/g, and a glass transition temperature of 56° C.

C) Preparation of Blocked Isocyanate Components

### Example 1

699.8 g of Desmodur N 3300 (polyisocyanato-isocyanurate based on hexamethylene diisocyanate, from Bayer) and 1632.8 g of VESTANAT T 1890 (polyisocyanato-isocyanurate based on isophorone diisocyanate, from Degussa) were heated to 100° C. 3.5 g of dibutyltin dilaurate were added. Thereafter, in portions, 1163.9 g of ε-caprolactam were added. An hour after the last portion of ε-caprolactam the reaction was at an end. The reaction mixture was subsequently cooled to room temperature. The reaction product had a free NCO group content of 0.4%, a total NCO content of 12.0%, and a melting range of 88-91° C.

### Example 2

A stream made up of 2307.7 g of IPDI uretdione and 3.1 g of DBTL is fed at a temperature of from 60 to 110° C. into the first barrel of a twin-screw extruder. At the same time, 839.4 g of a mixture of butane-1,4-diol, the diester of butane-1,4-diol and adipic acid (OH number of the mixture: 802 mg KOH/g) are metered in with a temperature of from 25 to 150° C. The reaction product is cooled, fractionated, and ground. It has a free NCO content of 0.1% and a latent NCO content of 13.5%.

D) Polyurethane Powder Coating Materials

General Preparation Procedure

The comminuted products—blocked polyisocyanate (crosslinker), polyester, leveling agent, devolatilizer, and catalyst masterbatch—are intimately mixed with the white pigment in an edge runner mill and the mixture is then homogenized in an extruder at up to 130° C. After cooling, the extrudate is crushed and ground to a particle size <63 μm using a pinned-disk mill. The powder thus produced is applied to degreased, iron-phosphated steel panels using an electrostatic powder spraying unit at 60 kV, and the applied coating is baked in a coil coating oven.

The formulations contained 30% by weight of Kronos 2160 (titanium dioxide from Kronos), 1% by weight of Resiflow PV 88 (leveling agent from Worlee-Chemie), 0.5% by weight of Benzoin (devolatilizer from Merck-Schuchardt) and 0.1% by weight of dibutyltin dilaurate (catalyst from Crompton Vinyl Additives GmbH). The OH/NCO ratio was 1:1.

TABLE 1
Data for white-pigmented, matt PUR powder coil coatings

| | | | |
|---|---|---|---|
| Polyurea A) | 10.0 g A) 1 | 25.0 g A) 1 | 15.0 g A) 1 |
| Polyester B) | 9.2 g B) 1 | 14.1 g B) 1 | 41.3 g B) 2 |
| | 36.7 g B) 2 | 21.3 g B) 2 | |
| Isocyanate C) | 12.5 g C) 1 | 8.0 g C) 2 | 12.1 g C) 1 |
| Baking conditions | 232° C./65 | 232° C./65 | 232° C./65 |
| | sec | sec | sec |
| Film thickness | 50-61 | 31-44 | 35-59 |
| (μm) | | | |
| Gloss 60° angle | 60 | 25 | 45 |
| Cupping (mm) | >10 | >10 | >10 |
| BI dir./indir. (inch | >80/>80 | >80/>80 | >80/>80 |
| lb) | | | |
| T-bend | 0 T | 0 T | 0 T |

Key:
Gloss 60° angle = Gardner gloss measurement (ASTM-D 5233)
Cupping = Erichsen cupping (DIN 53 156)
BI dir./indir. = direct and indirect ball impact (ASTM D 2794-93)
T-bend = deformation test (ECCA T 7)

The disclosure of the priority document, German Patent Application No. 102 33 104.9, filed Jul. 20, 2002, is incorporated by reference herein in its entirety.

What is claimed is:

1. A coating method comprising coating polyurethane powder coating materials on a metal substrate, wherein the polyurethane powder coating materials comprise
A) 3-25% by weight of a polyurea;
B) 35-75% by weight of at least one amorphous or semicrystalline polyester having a hydroxyl number of from 5 to 250 mg KOH/g and a melting point of from 50 to 130° C.;
C) 5-30% by weight of at least one crosslinker based on one or more of blocked polyisocyanates, blocked isocyanurates and uretdiones having a functionality of at least 2; and
D) 0.5-50% by weight of auxiliaries and additives, where component C) has 0.5 to 1.2 NCO groups available per OH group of component B).

2. The method according to claim 1, further comprising
homogenizing the polyurethane powder coating materials in a melt;
cooling the melt to form a solid; and
pulverizing the solid to form a powder; wherein
the coating comprises depositing the powder on the metal substrate.

3. The method according to claim 2, wherein the powder consists of particles each having a particle size of less than 100 μm.

4. The method according to claim 1, further comprising curing the polyurethane powder coating materials on the metal substrate.

5. The method according to claim 1, wherein the coating comprises electrostatically spraying the polyurethane powder coating materials on the metal substrate.

6. The method according to claim 1, wherein the coating comprises fluidized-bed sintering of the polyurethane powder coating materials on the metal substrate with or without electrostatic assistance.

7. The method according to claim 1, wherein the polyurea A) is produced from monomers comprising
at least one isocyanate having a functionality of at least two; and
at least one amine having a functionality of at least two,
where an NCO/NH₂ ratio of the at least one isocyanate and the at least one amine is from 0.9-1.1:1.

8. The method according to claim 7, wherein the at least one isocyanate having a functionality of at least two comprises an isocyanurate.

9. The method according to claim 7, wherein the at least one isocyanate having a functionality of at least two is selected from the group consisting of isophorone diisocyanate, hexamethylene diisocyanate and 4,4′-dicyclohexylmethane diisocyanate.

10. The method according to claim 7, wherein the at least one amine having a functionality of at least two is selected from the group consisting of aliphatic diamines, cycloaliphatic diamines, aromatic diamines and polyamines having 5-18 carbon atoms.

11. The method according to claim 7, wherein the at least one amine having a functionality of at least two comprises isophoronediamine.

12. The method according to claim 1, wherein the component B) comprises an amorphous polyester.

13. The method according to claim 12, wherein the amorphous polyester has a functionality of from 2.0 to 5.0, an OH number of from 5 to 250 mg KOH/g, a viscosity at 160° C. of <60,000 m·Pas, and a melting point of from 50° C. to 130° C.

14. The method according to claim 1, wherein the component B) comprises a semicrystalline polyester.

15. The method according to claim 14, wherein the semicrystalline polyester has a functionality of from 2.0 to 4.0, an OH number of from 5 to 250 mg KOH/g, a melting point of from 50° C. to 130° C., and a glass transition temperature of <−10° C.

16. The method according to claim 1, wherein the crosslinker C) is produced from starting components including at least one diisocyanate selected from the group consisting of isophorone diisocyanate, hexamethylene diisocyanate and 4,4′-dicyclohexylmethane diisocyanate.

17. The method according to claim 1, wherein the crosslinker C) is blocked with at least one member of the group consisting of caprolactam, triazoles, oximes and pyrazoles.

18. The method according to claim 1, wherein the auxiliaries and additives D) comprise at least one member of the group consisting of leveling agents, pigments, fillers, dyes, catalysts, light stabilizers, heat stabilizers, antioxidants and effect additives.

19. A coated metal substrate comprising a metal substrate and a coating on the metal substrate, wherein the coating has a matt appearance and is produced by a coating process from polyurethane powder coating materials comprising
A) 3-25% by weight of a polyurea;
B) 35-75% by weight of at least one amorphous or semicrystalline polyester having a hydroxyl number of from 5 to 250 mg KOH/g and a melting point of from 50 to 130° C.;
C) 5-30% by weight of at least one crosslinker based on one or more of blocked polyisocyanates, blocked isocyanurates and uretdiones having a functionality of at least 2; and
D) 0.5-50% by weight of auxiliaries and additives,
where component C) has 0.5 to 1.2 NCO groups available per OH group of component B).

20. The coated metal substrate according to claim 19, wherein the coated metal substrate has, at an angle of 60°, a gloss level in a range of from 1 to 70.
